(19) United States
(12) Patent Application Publication
(10) Pub. No.: US 2018/0345231 A1
(43) Pub. Date: Dec. 6, 2018

(54) METHOD AND APPARATUS FOR RELEASING GAS

(71) Applicant: The New Zealand Institute for Plant and Food Research Limited, Auckland (NZ)

(72) Inventors: Hamish John Alexander Elmslie, Auckland (NZ); Benjamin Martin King, Pattons Rock, Takaka (NZ)

(73) Assignee: The New Zealand Institute for Plant and Food Reasearch Limited, Auckland (NZ)

(21) Appl. No.: 15/777,960

(22) PCT Filed: Nov. 18, 2016
(86) PCT No.: PCT/NZ2016/050184

§ 371 Date: May 22, 2018

(30) Foreign Application Priority Data
Nov. 23, 2015 (NZ) 714409

(51) Int. Cl. B01F 3/04; B01F 13/00; C12H 1/22; C12H 1/14; C12L 11/00

(52) U.S. Cl. CPC B01F 3/04808; B01F 13/0049; C12H 1/22; B01F 2215/007; C12L 11/00; B01F 2003/04879; C12H 1/14

(57) ABSTRACT

An apparatus for releasing a gas into a liquid housed in a container has a gas assembly including a source of compressed gas; a float in fluid communication with the source of compressed gas; and a gas release member in fluid communication with the source of compressed gas and the float. The gas release member is adapted to release gas into the liquid. The float has variable buoyancy that causes the float and the gas release member to ascend and descend depending on the buoyancy of the float, the buoyancy of the float being reduced as the gas is released into the liquid.

### FIELD

This disclosure relates to an apparatus and method for release of gas into a liquid.

### BACKGROUND

To improve the colour, taste and mouth-feel of wine, the wine is typically matured for a period of time. That maturation process has traditionally taken place inside oak barrels. The oak naturally lets in small amounts of oxygen that develop the tannins in the wine to result in a more palatable product. As the scale of wine production increases, winemakers are producing wine in large steel tanks to allow for larger production volumes. However, steel isn't permeable to oxygen, which inhibits the maturation of the wine. Instead, winemakers use dedicated micro-oxygenation systems to mimic the oxygen permeated in barrels. Not only does the micro-oxygenation process improve colour taste and mouth-feel, it can speed up the maturation process allowing wines to be brought to market in a shorter time frame compared to untreated wines and barrel aged wines. A major drawback with known micro-oxygenation systems is that the initial cost and complexity of the systems are prohibitive for many winemakers.

Known micro-oxygenation systems typically operate through a bubble plume diffusion method. That method involves releasing small bubbles of oxygen near the bottom of a tank through a diffuser. The oxygen is absorbed by the wine as it travels upwards. The efficacy of such a method is determined by the size of the bubbles and the depth of the tank.

It is an object of at least preferred embodiments of the present invention to provide an apparatus and method for release of gas into a liquid to improve the qualities of the liquid. It is an additional or alternative object of at least preferred embodiments of the present invention to at least provide the public with a useful alternative.

### SUMMARY OF THE INVENTION

In accordance with a first aspect of the invention, there is provided an apparatus for releasing a gas into a liquid housed in a container, the apparatus comprising:

a. a gas assembly including a source of compressed gas;

b. a float in fluid communication with the source of compressed gas; and

c. a gas release member in fluid communication with the source of compressed gas and the float, the gas release member being adapted to release gas into the liquid;

wherein the float has variable buoyancy that causes the float and the gas release member to ascend and descend depending on the buoyancy of the float, the buoyancy of the float being reduced as the gas is released into the liquid.

In an embodiment, the source of compressed gas is adapted to be provided outside the container, and the float and the gas release member are adapted to be housed within the container. In an alternative embodiment, the source of compressed gas, the float, and the gas release member are a self-contained assembly that is adapted to be housed within the container.

In an embodiment, the membrane extends between the gas assembly and the float.

In an embodiment, the membrane partially extends between the source of compressed gas and the float.

In an embodiment, the membrane comprises a flexible tube.

In an embodiment, the float is shaped to create a hydrodynamic effect that causes the float to move generally laterally as it ascends and/or descends.

In an embodiment, the float has one or more laterally extending fins.

In an embodiment, the apparatus further comprises a valve for controlling the flow of gas from the source of gas to the float and membrane.

In an embodiment, the gas is or comprises one or more of oxygen, sulphur dioxide, carbon dioxide, and/or nitrogen, either alone or in combination.

In an embodiment, the gas is or comprises oxygen.

In an embodiment, the gas is infused with one or more flavours or aromas.

In accordance with a second aspect of the invention, there is provided a method of releasing a gas into a liquid comprising:

a. providing a container containing a liquid;

b. providing a source of gas, a float in fluid communication with the source of gas, and a gas release member in fluid communication with the source of gas and the float;

c. placing the float and the gas release member in the liquid in the container;

d. delivering gas into the gas release member and the float thereby increasing the buoyancy of the float, releasing the gas from the source of gas through the gas release member into the liquid thereby reducing the buoyancy of the float; and

e. allowing the float to ascend and descend within the liquid in the container depending on the relative buoyancy of the float.

In an embodiment, the method further comprises controlling the flow of gas from the source of gas to the float and the gas release member such that when the pressure within the float reaches an upper threshold, the flow of gas from the source of gas is reduced or prevented and when the pressure within the float drops to a lower threshold, the gas is allowed to flow from the source of gas to the float and the gas release member.

In an embodiment, the flow of gas from the source of gas to the float and the gas release member is controlled periodically in a cycle in which gas is released for a first period of time and is not released for a second period of time.

In an embodiment, the cycle is between about 20 minutes and about 24 hours.

In an embodiment, the float moves laterally within the liquid in the container as it ascends and descends.

In an embodiment, the gas is or comprises one or more of oxygen, sulphur dioxide, carbon dioxide, and/or nitrogen.

In an embodiment, the gas is or comprises oxygen.

In an embodiment, the liquid is a beverage.

In an embodiment, the beverage is wine.

The term ‘comprising’ as used in this specification and claims means ‘consisting at least in part of’. When interpreting statements in this specification and claims which include the term ‘comprising’, other features besides the features prefaced by this term in each statement can also be present. Related terms such as ‘comprise’ and ‘comprised’ are to be interpreted in a similar manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting. Where specific integers are mentioned herein which have known equivalents in the art to which this invention relates, such known equivalents are deemed to be incorporated herein as if individually set forth.

As used herein the term ‘(s)’ following a noun means the plural and/or singular form of that noun.

As used herein the term ‘and/or’ means ‘and’ or ‘or’, or where the context allows both. The invention consists in the foregoing and also envisages constructions of which the following gives examples only.

### BRIEF DESCRIPTION OF THE DRAWINGS

The present invention will now be described by way of example only and with reference to the accompanying drawings in which:

FIG. 1 is an exploded perspective view of a compressed gas source, regulator, valve, and housing for those components;

FIG. 2 is a perspective view of the housing containing the compressed gas source, regulator, and valve;

FIG. 3 is a perspective view of the compressed gas source, regulator, and valve assembled together;

FIG. 4 is an exploded perspective view of a float;

FIG. 5 is a perspective view of the apparatus with the float in a relatively non-buoyant position;

FIG. 6 is a perspective view of the apparatus with the float in a relatively buoyant position;

FIG. 7 is a front view of an alternative embodiment float;

FIG. 8 is a perspective view of the float of FIG. 7;

FIG. 9 is a side view of the float of FIG. 7;

FIG. 10 is a perspective cross-section of an alternative embodiment float in a relatively negative buoyancy configuration;

FIG. 11 is a view similar to FIG. 10 showing the float in a relatively positive buoyancy configuration;

FIG. 12 is a schematic perspective view of a tank having the apparatus of FIG. 5 in a relatively positively buoyant position;

FIG. 13 is a schematic perspective view of a tank having the apparatus of FIG. 5 in a relatively negatively buoyant position;

FIG. 14 is a schematic perspective view of a tank with the membrane and float in the container and the other components will be provided outside the tank;

FIG. 15 shows a control system for monitoring and/or controlling the apparatus;

FIG. 16 shows a graph of membrane pressure over time;

FIG. 17 shows a graph of membrane pressure over time;

FIG. 18 shows an aggregate attribute ranking comparing Pinot Noir treated by an embodiment of the apparatus, an existing micro oxygenation system and a control;

FIG. 19 shows an aggregate attribute ranking comparing Merlot treated by an embodiment of the apparatus, an existing micro oxygenation system and a control;

FIG. 20 shows a graph of the release of oxygen during the trial; and

FIG. 21 shows a graph of the release of oxygen collected during the trial.

### DETAILED DESCRIPTION

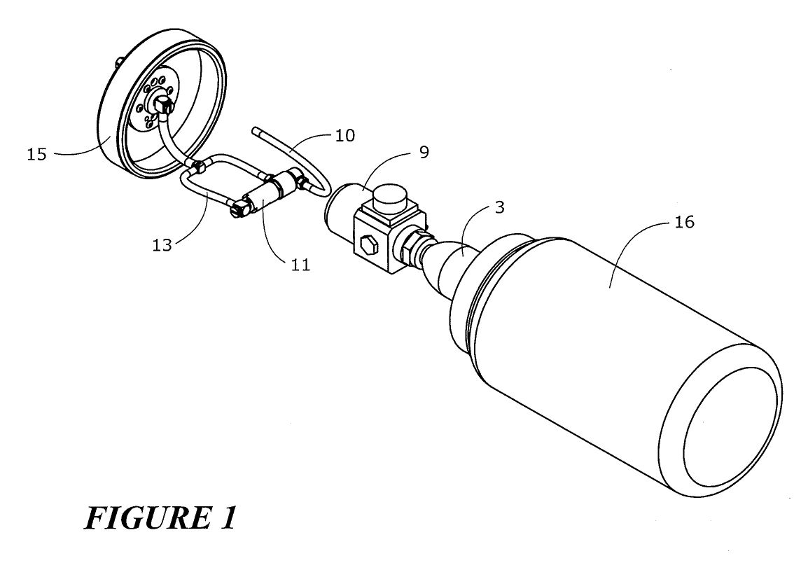

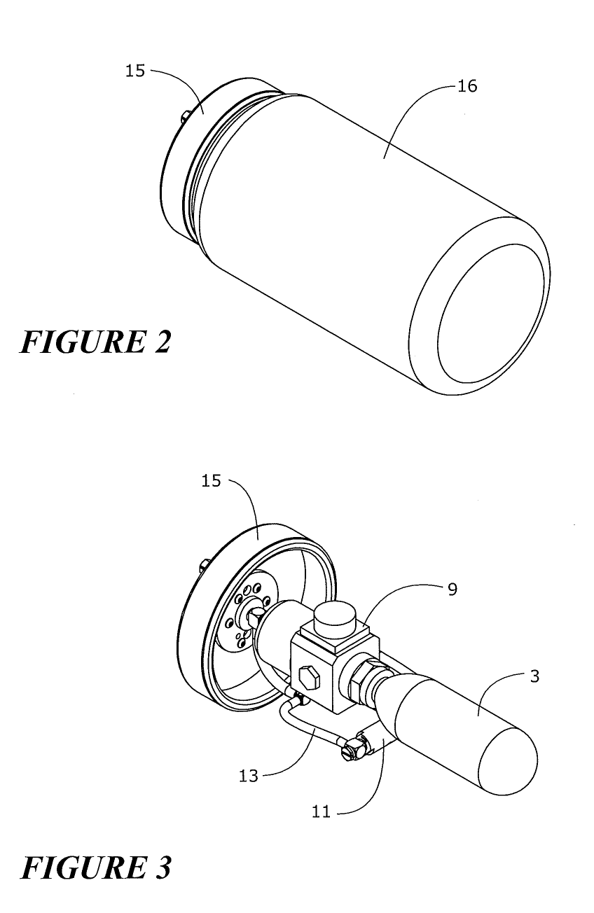

With reference to FIGS. 1 to 6, 12 and 13, a preferred embodiment apparatus for releasing a gas into a liquid housed in a container 100 is shown. The apparatus is indicated generally by reference number 1. The container 100 may be a vat, barrel, tank, reservoir or any other container that is used to store, age, and/or transport liquid. The container may be a steel tank or a traditional wooden barrel, for example, if the barrel pores are clogged after being used a number of times.

The apparatus 1 comprises a source of compressed gas in the form of a gas cartridge 3, a float 5, and a gas release member in the form of a membrane 7. The gas cartridge is associated with a pressure regulator 9 and a pilot valve 11. Together with a pressure feedback tube 13, the valve 11 controls the flow of gas from the cartridge via a tube 10 to the membrane 7. The pressure at which the valve 11 opens and closes is matched with the diffusion rate of the membrane. The pressure regulator 9, tube 10, pilot valve 11, and feedback tube 13 are housed in a housing 16 having a lid 15. The pressure regulator may be adjustable. The features and function of the float 5 are similar to a syringe. The plunger may have a membrane seal that will have little or no sliding friction.

The float 5 is in fluid communication with the gas cartridge 3 so that gas can be delivered from the gas cartridge 3 to the float 5. The membrane 7 is in fluid communication with the gas cartridge 3 and the float 5. In particular, the membrane 7 delivers gas from the gas cartridge 3 to the float 5. The membrane 7 is also adapted to release gas into the liquid L.

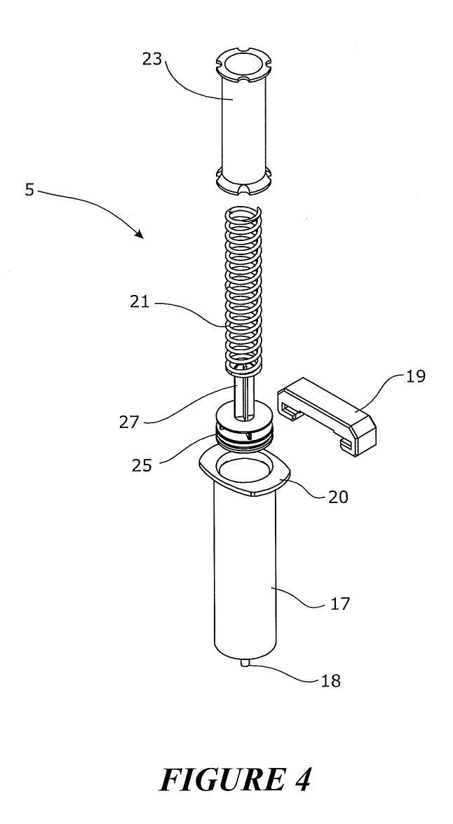

With reference to FIGS. 4 to 6, a first embodiment of the float is shown. The float 5 has variable buoyancy that causes the float 5 to ascend and descend in the liquid L depending on the buoyancy of the float 5. The float 5 has a housing 17 and a gas port 18 in fluid communication with the membrane 7.

The housing 17 also includes end cap 19 connected to a flange 20 of the housing. Within the housing 17, there is provided a spring 21, a spacer 23, and a plunger 25 having a shaft 27. The spacer 23 sets the spring tension and can be removed and replaced with a shorter or longer spacer to adjust the spring tension. The spring tension is matched with the diffusion rate of the membrane 7. The spacer 23 and spring 21 are held in the housing 17 by the end cap 19. The gas port 18 is coupled to the membrane 7 so gas can flow between the interior of the membrane 7 and the interior of the housing 17 between the port 18 and the plunger 25.

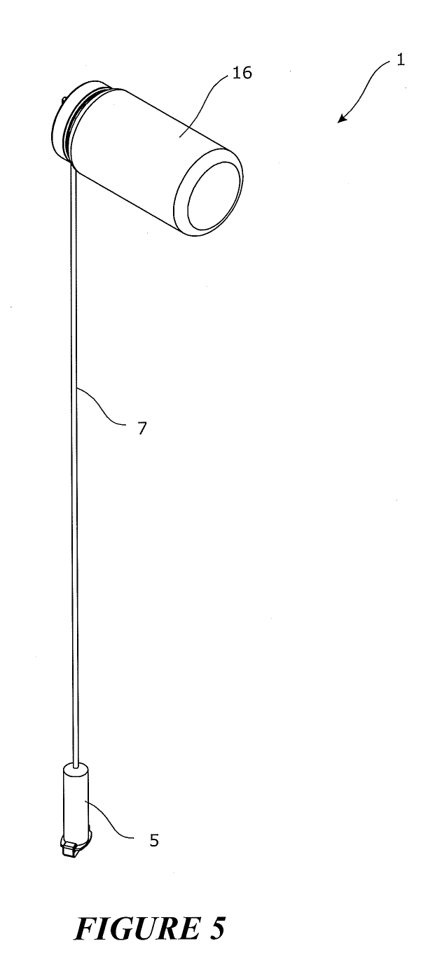

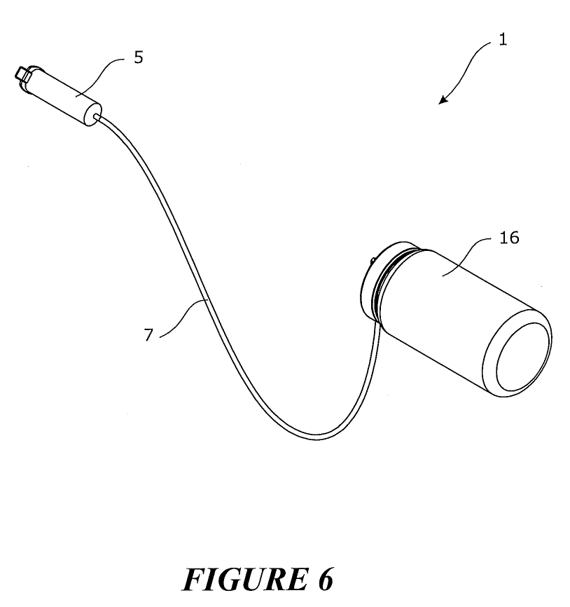

When gas is initially released into the membrane 7 and float 5, the gas pressure will be relatively high and will act against the plunger 25 and the spring 21 causing the plunger to move towards the end cap 19. That causes the float 5 to have a relatively positive buoyancy and float in the liquid L, as shown in FIG. 6. Over time, the gas will be released through the membrane 7 and the pressure in the float 5 will drop. The spring 21 will cause the plunger 25 to move away from the end cap 19. The float will have a relatively negative buoyancy and drop, as shown in FIG. 5.

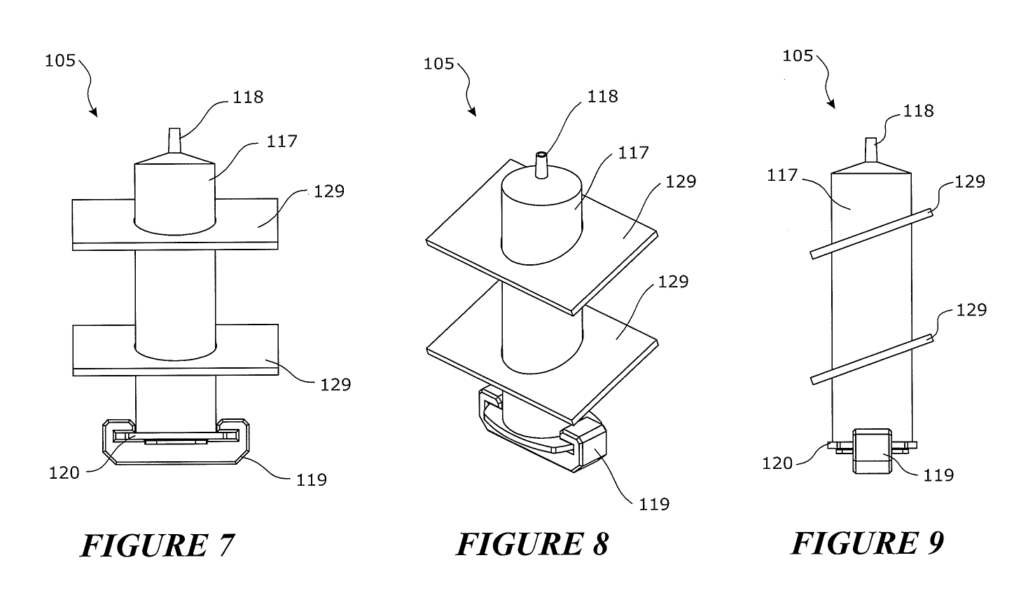

With reference to FIGS. 7 to 9, there is shown an alternative embodiment float 105. The alternative embodiment float 105 has similar features and functions to the float shown and described in relation to FIGS. 4 to 6 and like numbers are used to indicate like parts. The difference is that the float 105 is shaped to create a hydrodynamic effect that causes the float 105 to move laterally as it ascends and/or descends in the liquid L.

In the embodiment shown, the float 105 has one or more laterally extending fins 129. In the preferred embodiment shown, the float has two fins 129. The fins 129 are substantially rectangular when viewed from above, but may have other shapes, such as hexagonal, circular, or triangular. The fins 129 extend at an angle relative to the length of the float housing. That angle has a hydrodynamic effect that causes the float to move laterally as it ascends or descends in the liquid L.

In addition, any embodiment described above may also provide lateral movement by creating a fluid jet into the float design so that when the float fills with gas, fluid is rapidly displaced and creates a hydrodynamic force. Additionally or alternatively, lateral movement may be provided by a shaped membrane, that is, the membrane may have a curved shaped.

In this embodiment, the end cap 119 is also a weight that maintains the vertical orientation of the float 105 as it moves about the container 100. The weight 119 is attached to a flange 120 of the float housing 117.

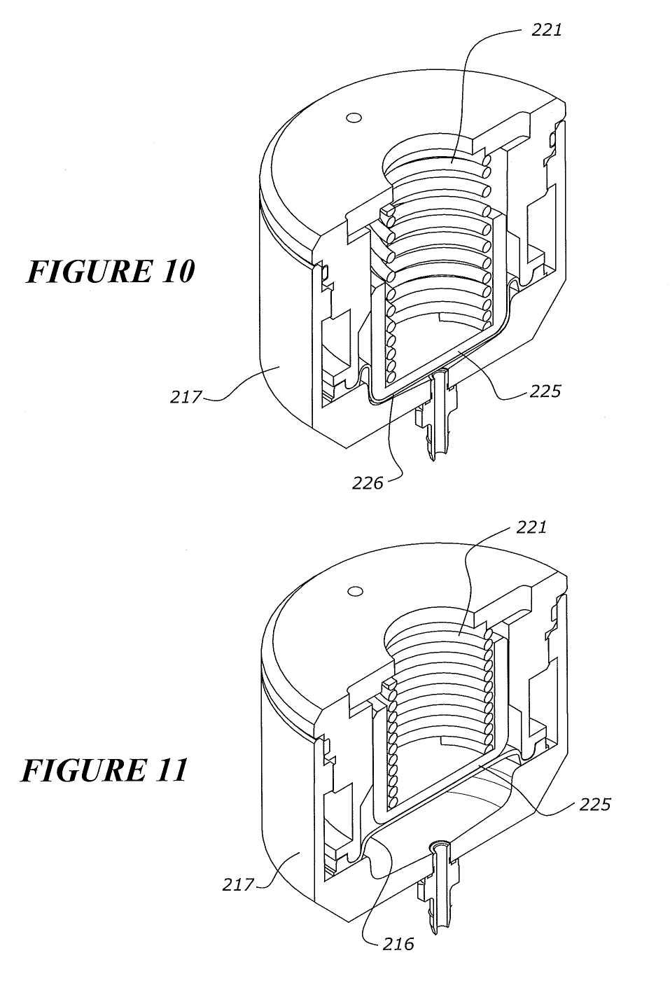

With reference to FIGS. 10 and 11, there is shown a third embodiment of a float 205. The third embodiment float 205 has similar features and functions to the first embodiment float shown and described in relation to FIGS. 4 to 6 and like numbers are used to indicate like parts. This float has a housing 217, a piston 225, and a seal 216. One difference is that the seal 216 is a rolling seal that changes shape as required when the piston moves, rather than sliding along the housing when the piston moves. As a consequence, there is very little or no friction caused by the piston movement.

The rolling seal 216 is attached to the housing 217 and attached to the piston 225. As the piston 225 moves from the position shown in FIG. 10, the rolling seal 216 unfolds until it reaches the position shown in FIG. 11.

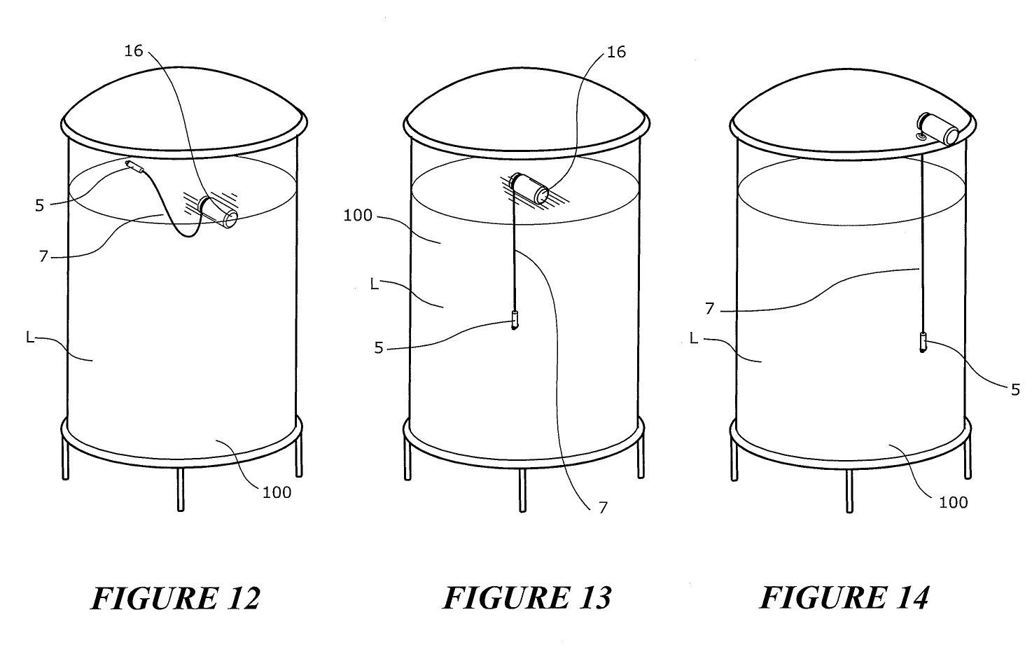

The membrane 7 is caused to travel through the liquid L as the float 5 travels through the liquid. The membrane 7 is suitably flexible to both move and change shape as the float 5/105 travels through the liquid L. For example, FIGS. 5 and 13 shows the membrane 7 dropping straight down from the housing 16 because the float 5 is negatively buoyant. FIGS. 6 and 12 show the membrane 7 having a curved shape because the float 5 is positively buoyant and spaced away from the housing 16.

In the embodiment shown, the membrane 7 extends between the housing 16 and the float 5. In an alternative embodiment, the membrane 7 may partially extend between the housing 16 and the float 5. In this alternative embodiment, the apparatus 1 may have a low permeability or very low permeability tube extending from the housing 16 to the membrane 7. Additionally or alternatively, the apparatus may have a non-permeable tube extending from the float to the membrane 7.

The membrane 7 comprises a silicone tube that releases gas into the liquid. In alternative embodiments, the membrane may be formed from other gas permeable materials. The gas may diffuse into the liquid either as bubbles or dissolve directly into the liquid. Two examples of example of suitable, commercially available membranes are:

Tygon 3350 produced by Saint-Gobain

Material: Platinum-cured silicone tubing

Length: 2 meters

Membrane inside diameter: 3 mm

Membrane outside diameter: 6 mm

Membrane wall thickness: 1.5 mm

Versilic SPX-50 produced by Saint-Gobain

Material: silicone tubing

Length: 2 meters

Membrane inside diameter: 3 mm

Membrane outside diameter: 6 mm

Membrane wall thickness: 1.5 mm

Typically membranes may range from anywhere between (but not limited to) 0.5 m to 5 m in length. It will be appreciated that the length may be chosen or determined by the oxygen release rate required for the particular wine and/or the size of the wine container and amount of wine contained therein. Examples of oxygen release rates for specific wine varieties are:

Merlot=1-5 mg/L/month.

Pinot Noir=1-2 mg/L/month.

Chardonnay=1-2 mg/L/month.

For example, the membrane 7 length may be about 0.6 m, 0.7 m, 0.8 m, 0.9 m, 1.0 m, 1.1 m 1.2 m, 1.3 m, 1.4 m, 1.5 m, 1.6 m, 1.7 m, 1.8 m, 1.9 m, 2.0 m, 2.1 m 2.2 m, 2.3 m, 2.4 m, 2.5 m, 2.6 m, 2.7 m, 2.8 m, 2.9 m, 3.0 m, 3.1 m 3.2 m, 3.3 m, 3.4 m, 3.5 m, 3.6 m, 3.7 m, 3.8 m, 3.9 m, 4.0 m, 4.1 m, 4.2 m, 4.3 m, 4.4 m, 4.5 m, 4.6 m, 4.7 m, 4.8 m, 4.9 m, or 5.0 m.

The membrane length is one of a number of parameters that can be adjusted to determine the oxygen release rate. Other parameters include pressure, membrane material, membrane wall thickness, membrane diameter, and the wine itself.

The gas is or comprises one or more of oxygen, sulphur dioxide, carbon dioxide, and/or nitrogen, either alone or in combination. In the preferred embodiment, the gas is or comprises oxygen. In some embodiments, the gas may be infused with one or more flavours or aromas, such as oak.

An advantage for including additional gas(es) alongside oxygen within the apparatus is that the additional gas will have a direct reaction within the wine to improve the flavours, colour, and/or texture or to remove undesirable characteristics.

In one embodiment, the gas cartridge 3, the float 5, and the membrane 7 are a self-contained assembly that is adapted to be housed entirely within the container 100. That is, there is no part of that assembly outside the container 100. That embodiment is shown in FIGS. 5 and 6. An advantage of this embodiment is that the apparatus can be used with a conventional wine tank or wine barrel without modifications or external equipment. The device requires little or no input from an operator once introduced into a container 100.

FIG. 14 shows an alternative embodiment in which the float 5 and the membrane 7 may be provided in the container 100, but the other components will be provided outside the container. In particular, the gas cartridge 3, pressure regulator 9, and the valve 11 may be outside the container 100.

A tube could extend through an aperture, entrance port or bung of the container 100 and supply gas to the membrane 7 in the liquid L. In another alternative embodiment, the housing could be mounted to the exterior of the container 100 in place of the bung/lid.

Those components may be in a housing 16. An advantage of this embodiment is that it is relatively easy for an operator to access the gas cartridge 3 to check it is operating and replace the gas cartridge 3.

The various components of the apparatus that come into contact with the liquid are food grade materials. For example, the membrane is formed from a food grade silicon, the housing, float housing, and end cap are each formed from a food grade plastic material. The valve is formed from brass and stainless steel and the cartridge is formed from steel.

A method of releasing a gas into a liquid will now be described. The method comprises placing the float and the housing containing the gas cartridge and valve 11 in the liquid in the container 100.

In use, the gas is released into the membrane 7 from the gas cartridge 3 through the valve 11. The gas pressure acts against the plunger 27 in the float 5 causing the plunger to move upwardly and the float becomes buoyant and floats upwardly. The pressure in the membrane 7 and float 5 feeds back to the valve 11 causing it to close. The gas diffuses through the membrane 7 into the liquid. The pressure in the float 5 decreases to an intermediate pressure and the float 5 becomes negatively buoyant and sinks. The gas continues to diffuse into the liquid from the membrane 7. At a low pressure threshold, the valve 11 opens and the cycle begins again.

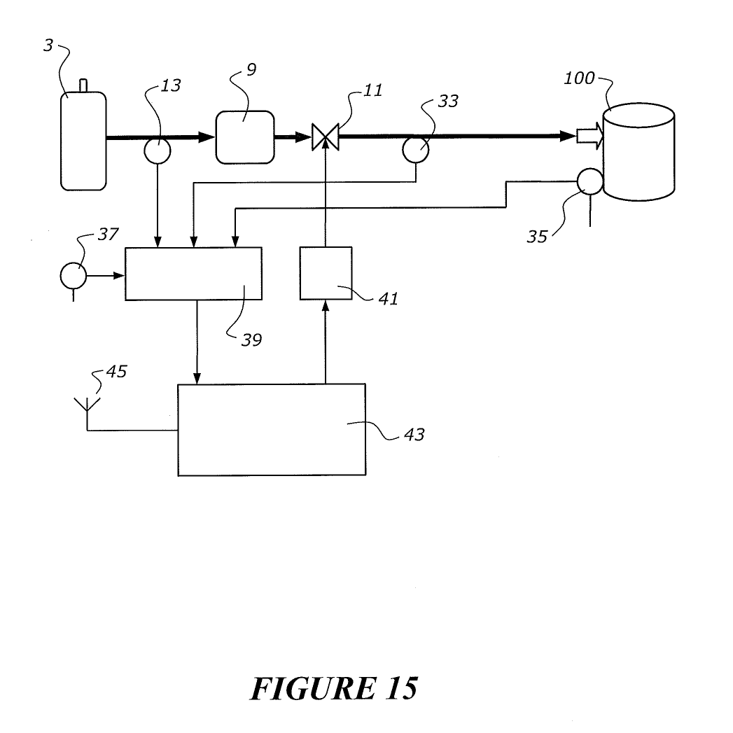

FIG. 15 shows a control system for monitoring and/or controlling an alternative embodiment of the apparatus. The control system of this alternative embodiment operates to provide gas from the gas cartridge to the float and the membrane by operating a solenoid valve based on feedback from a plurality of sensors. It will be appreciated that FIG. 15 is one possible way to control the pressure. Other methods are also possible. FIG. 15 shows a pressure sensor 13 between the oxygen tank 3 and a pressure regulator 9. Another pressure sensor 33 is located in the float, or may be located to measure pressure in the membrane. A temperature sensor 35 measures the temperature of the wine in the tank. An ambient temperature sensor 37 measures the ambient temperature. The system carries out signal conditioning at 39 based on data received from the ambient temperature sensor, the pressure sensors, and the temperature sensor of the tank. Data is then sent to a microcontroller, which will send a signal to a valve driver to operate the solenoid valve. When the pressure of the gas in the float reaches the low pressure threshold, the control system will operate the solenoid valve. The system may have one low pressure threshold and one high pressure threshold. Alternatively, the system may operate in bands of pressure thresholds.

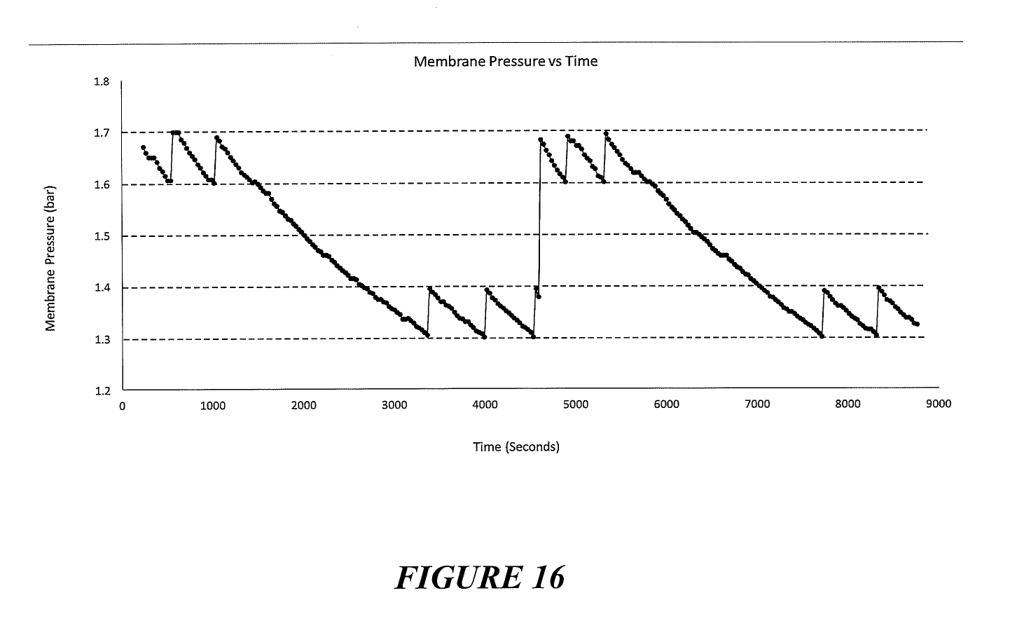

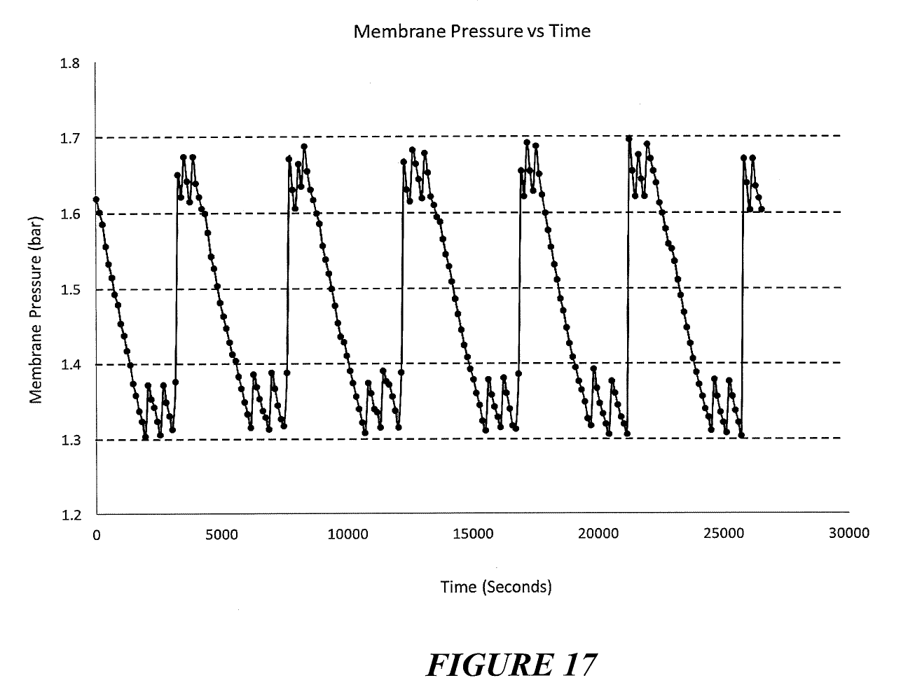

FIGS. 16 and 17 show graphs of the pressure in the float membrane over time in which the system operates in bands of pressure. Each graph shows that the membrane pressure alternates between two bands of pressure and within each band of pressure: one band has a relatively higher pressure and corresponds to the float being positioned relatively high in the tank of wine. Within the band of pressure, the graphs show that the pressure changes over time and alternates between about 1.6 bar and about 1.7 bar.

The other band has a relatively lower pressure and corresponds to the float being positioned relatively low in the tank of wine. For example, the float may be positioned at or near the middle of the tank, or at or near the bottom of the tank. Within the band of pressure, the graphs show that the pressure changes over time and alternates between about 1.3 bar and about 1.4 bar.

The float moves when the pressure transitions between the two bands by passing through a neutral buoyancy point, which, in the case of FIGS. 16 & 17 is at 1.5 bar. Additionally, the position of the float when negatively buoyant (or in the lower pressure band) will be dictated by the length of the membrane. When the float is positively buoyant (or in the upper pressure band) the float will remain on the surface of the liquid.

The neutral buoyance pressure can be determined as follows:

1. Allow float pressure to drop to zero (or do this before any oxygen has been put into the membrane).

2. Slowly increase the pressure in the membrane at, say, 0.05 bar increments every 30 seconds.

3. Monitor the pressure in membrane continuously.

4. As the pressure reached the neutral buoyancy point and goes beyond it, a pressure change in the membrane can be detected that is reflective of the hydrostatic pressure change due to the float rising up in the liquid and thus having a decrease in hydrostatic pressure.

The housing 16 may float in the liquid L or move downwardly towards the bottom of the container 100. The housing may tilt, float, or move downwardly depending on the amount of oxygen remaining in the cartridge 3. In addition to the membrane 7 and float 5 moving, the housing 16 may also move.

Moving the membrane 7 allows for a better overall distribution of oxygen throughout the tank of liquid L. By moving the membrane 7 periodically, a greater proportion of the liquid comes into close proximity to the membrane 7 compared to a membrane that is stationary or relatively stationary. As a result, the active float provides a more effective micro-oxygenation treatment compared to a membrane that is stationary or relatively stationary.

By moving the active float through the liquid L, a build-up of oxygen around the outside of the membrane 7 is prevented, or at least substantially inhibited, or at least reduced compared to a relatively stationary membrane. The process of introducing the oxygen into the liquid through a membrane is driven by the concentration differential. If the liquid around the membrane 7 becomes too saturated with oxygen, the release rate of oxygen through the membrane 7 may slow, or even stop completely. Periodically moving the membrane 7 prevents, or at least substantially inhibits, oxygen saturation. When the apparatus has the float 105 shown and described in relation to FIGS. 7 to 9, the float moves laterally within the liquid in the container as it ascends and descends.

In one embodiment, the flow of gas is controlled periodically in a cycle in which gas is released for a first period of time and is not released for a second period of time.

The method is preferably carried out for a number of cycles and those cycles repeat over a minimum of one month. The cycle may be between about 20 minutes and about 24 hours. The rate of oxygen release may be controlled to have different amounts of oxygen per litre over time. One example is:

5 mg of oxygen per litre for the first month.

3 mg of oxygen per litre for the second month.

1 mg of oxygen per litre for the third month.

In some embodiments, the method may include applying 1 mg of oxygen per litre of wine to ‘open’ the wine before delivery. It is also possible to apply oxygen using the apparatus and method described herein during transportation of the wine.

The operating parameters will be adjusted depending on the type of liquid that is being treated. The apparatus and method may be used for aging rum, beer, vinegar, sherry, whiskey, or brandy.

### Experimental Results

Using the preferred embodiment apparatus and method described above has given the following initial results:

Merlot

Membrane Type: Tygon 3350

Membrane Length: 2 m

Membrane Average Pressure: 1.45 bar

Average membrane cycle time: 55 minutes

Oxygen release rate: 15.45 grams per month

Volume of wine: 11,000 litres

Pinot Noir

Membrane Type: Tygon 3350

Membrane Length: 1 m

Membrane Average Pressure: 1.25 bar

Average membrane cycle time: 55 minutes

Oxygen release rate: 7.18 grams per month

Volume of wine: 11,000 litres

Comparative tests were performed with wine treated using the preferred embodiment apparatus and the same wine that had no oxygen treatment. The treated wine exhibited flavour differences compared to the untreated wine, indicative of oxygenation and aging of the treated wine.

Trial Background

A further detailed trial was conducted to test the suitability and performance of an embodiment of the apparatus for releasing a gas into a liquid. The trial was designed to assess and compare an embodiment of the apparatus against an existing micro oxygenation system and a control. The control was wine without any micro oxygenation system. The trial was carried out across six tanks and two wine varieties. Environmental factors were replicated as well as time spent in the act of winemaking. For example, all tanks were exposed to external oxygen for the same amount of time.

The wines were actively monitored throughout the trial with the resulting wine assessed by an independent laboratory at regular intervals throughout the trial.

Tank Setup

Six tanks were included in the trial, each tank had the following dimensions:
Height: 2.5 m
Diameter: 2.35 m
Capacity: 11,000

Tank Wine type Treatment Oxygen rate

Tank 1: Pinot Noir with an embodiment of apparatus for two months with a release rate of 1 mg of oxygen per litre per month

Tank 2: Pinot Noir with the competitor's apparatus for two months with a release rate of 1 mg of oxygen per litre per month

Tank 3: Pinot Noir Control for two months with a release rate of 0 mg of oxygen per litre per month

Tank 4: Merlot with an embodiment of apparatus for 1 month with a release rate of 2 mg of oxygen per litre per month

1 month with a release rate of 1 mg of oxygen per litre per month

Tank 5: Merlot with the competitor's apparatus for 1 month with a release rate of 2 mg

1 month with a release rate of 1 mg of oxygen per litre per month

Tank 6: Merlot Control for two months @ 0 mg of oxygen per litre per month

Winemaker Objectives

Objectives and characteristics of each wine were determined prior to the commencement of the trials. The Pinot Noir needed “to build body and soften tannins to give more depth and fullness to the wine”. The Merlot needed to ‘refine and soften tannins to bring depth across palate and less dryness on the finish”. These development objectives determined the oxygen flow rates required for each variety as described above in relation to the tank wine type treatment oxygen rate.

Monitoring the Trial: Blind Tastings

To assess the progress against the development goals, winemakers conducted systematic blind tastings of each wine at fortnightly intervals. Each sample was assessed on its taste and development, noting its individual attributes and comparing those to the other blind samples within its variety.

Independent Laboratory Analysis

Samples of each of the wines were taken and sent to an independent laboratory specialising in wine analysis where a Basic wine panel was conducted pre-trial and post-trial across each sample. This panel analysis consisted of measuring the pH, Titratable acidity (TA), Free and Total SO2, Alcohol, Acetic acid, Glucose/Fructose, Malic acid of the wine. Fortnightly testing and analysis was also conducted by the laboratory across the range of samples. In addition to this, the winemakers also conducted chemical analysis of the wines, assessing the changes in pH, Free and Total SO2, TA, volatile acidity as well as measuring the temperature, dissolved oxygen, hue, density and turbidity across the course of the trial.

Real Time Remote Monitoring

The apparatus may be used with real time monitoring of each unit. The monitoring allows monitoring of the performance, as well as remote adjustments to release rates of oxygen. This monitoring provided valuable feedback with respect to flow rate, pressure, float oscillations, oxygen levels and temperature. Real time monitoring was used during the trials and data was reported automatically every 5 minutes throughout the ten week trial providing a robust data set.

At the conclusion of the trials, a blind taste test was performed by a panel of winemakers to assess whether the different treatments were easily distinguishable from each other and to assess the individual attributes of each wine. The panel were provided with blind samples with the objective of establishing the taste profile across the 6 tanks, ranking how the preferred embodiment apparatus performed in relation to wine treated by the competitor and the control wine.

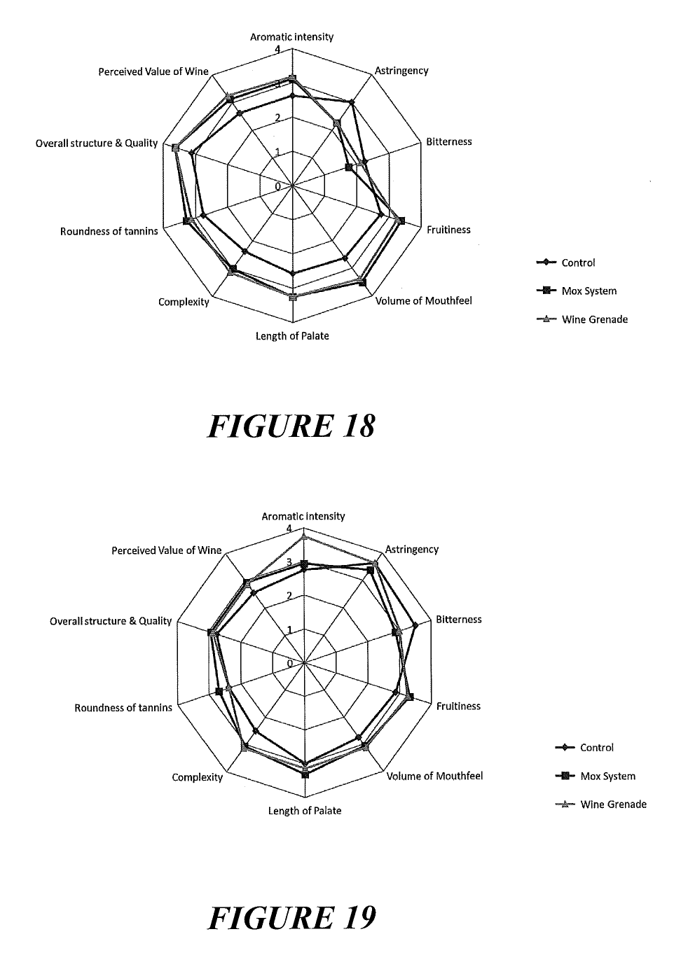

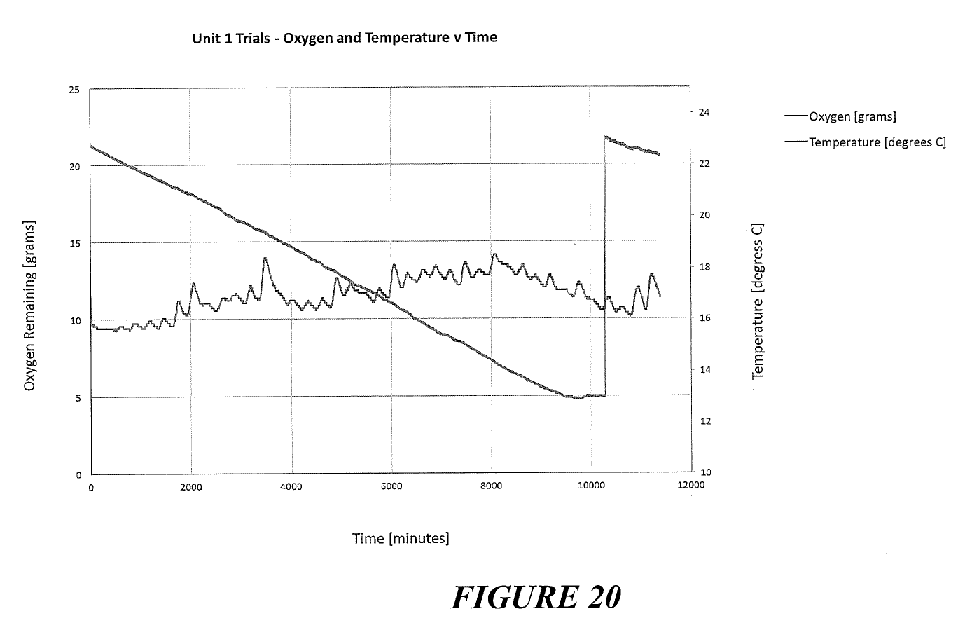

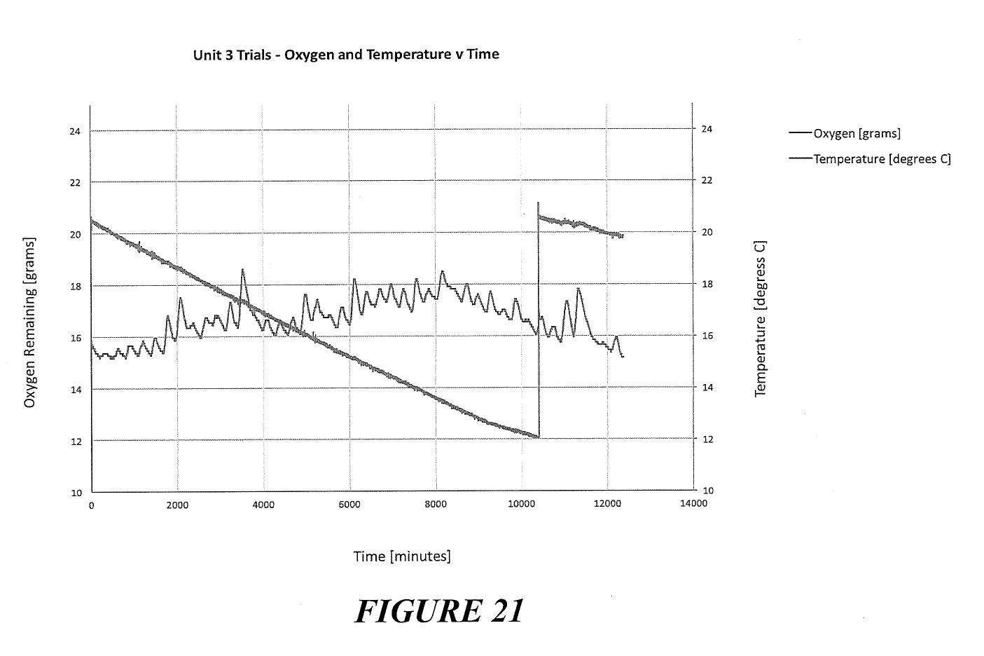

FIG. 18 shows an aggregate attribute ranking comparing Pinot Noir treated by an embodiment of the apparatus (indicated by the triangle symbol), the existing micro oxygenation system (indicated by the square symbol) and the control (indicated by the circle symbol).

FIG. 19 shows an aggregate attribute ranking comparing Merlot treated by an embodiment of the apparatus (indicated by the triangle symbol), the existing micro oxygenation system (indicated by the square symbol) and the control (indicated by the circle symbol).

As can be seen in FIGS. 18 and 19, the aggregated tasting panel attribute ranking showed that wine treated by an embodiment of the apparatus ranked equally or above the wine treated by the existing micro oxygenation system and the control wine across each of the ten different attributes.

Tasting Notes

The tasting notes taken throughout the trial also showed that the samples of wine treated with the preferred embodiment apparatus proved to be the most favourable sample within each wine variety at each sample point.

“Complex nose with red fruits and savory highlights. More depth on palate than D (Control) and more complexity than E (Competitor). Structure slightly more integrated into overall flow of wine than E (Competitor).

“Sweet blackberry aromas with some spicy lift. Richness and depth on entry, good complexity, leads to grainy tannins and low astringency. The most supple and balanced of these three wines.”

Most lifted of the three glasses with sweet dark baked fruits with a complexing savory note. Good depth on the attack which is well sustained through plate despite chewy structural tannins. No bitterness on the finish. Overall good balance to depth and structure.”

Remote Data Analysis

The data set generated by with the preferred embodiment apparatus also showed that the oxygen rates delivered by both units of the preferred embodiment apparatus stayed within the predetermined targets, delivering 13.04 and 6.66 grams per month for Units 1 (Merlot) and 3 (Pinot Noir) respectively. The data, when graphed, show a uniformed and consistent flow of oxygen. This is consistent with the feedback received from the winemakers who tracked the development of the wine as the oxygen was introduced.

Also encouraging to see was the reliable performance of the active float which oscillated every 30 minutes throughout the wine vat for the entire trial.

Independent Laboratory Analysis

An independent basic panel test was conducted. Analysis results show no noticeable variances between the three samples of each variety from a chemical analysis perspective. This demonstrates that the preferred embodiment apparatus is effectively improving the wine without having any chemical impact on the wine.

Basic Wine Panel Pre vs Post Trial

| | | Pinot Noir | | Merlot | |
|---|---|---|---|---|---|
| Control | Mox | WG | Control | Mox | WG |

Actual Alcoholic Strength (% v/v)

| | | | | | | |
|---|---|---|---|---|---|---|
| Pre Trial | 13.3 | 13.3 | 13.3 | 13.9 | 13.9 | 13.9 |
| Post Trial | 13.4 | 13.4 | 13.4 | 1390% | 13.9 | 13.9 |

Total Acidity (g/L as Tartaric Acid)

| | | | | | | |
|---|---|---|---|---|---|---|
| Pre Trial | 5.4 | 5.4 | 5.4 | 5.7 | 5.7 | 5.8 |
| Post Trial | 5.4 | 5.4 | 5.4 | 5.7 | 5.7 | 5.7 |

Volatile Acidity (g/L as Acetic Acid)

| | | | | | | |
|---|---|---|---|---|---|---|
| Pre Trial | 0.57 | 0.58 | 0.57 | 0.46 | 0.45 | 0.46 |
| Post Trial | 0.56 | 0.56 | 0.57 | 0.48 | 0.48 | 0.49 |

LMalic Acid* (g/L)

| | | | | | | |
|---|---|---|---|---|---|---|
| Pre Trial | 0.04 | 0.04 | 0.03 | 0.03 | 0.03 | 0.02 |
| Post Trial | 0.03 | 0.03 | 0.03 | 0.03 | 0.03 | 0.03 |

Total Sugars (g/L)

| | | | | | | |
|---|---|---|---|---|---|---|
| Pre Trial | 0.46 | 0.46 | 0.46 | 0.24 | 0.24 | 0.24 |
| Post Trial | 0.53 | 0.53 | 0.53 | 0.26 | 0.27 | 0.27 |

pH (pH Units)

| | | | | | | |
|---|---|---|---|---|---|---|
| Pre Trial | 3.72 | 3.72 | 3.73 | 3.66 | 3.66 | 3.67 |
| Post trial | 3.74 | 3.75 | 3.75 | 3.69 | 3.69 | 3.69 |

Total Sulphur Dioxide (mg/L)

| | | | | | | |
|---|---|---|---|---|---|---|
| Pre Trial | 29 | 30 | 29 | 35 | 36 | 36 |
| Post Trial | 24 | 25 | 24 | 24 | 21 | 21 |

Free Sulphur Dioxide (mg/L)

| | | | | | | |
|---|---|---|---|---|---|---|
| Pre Trial | 19 | 19 | 18 | 16 | 19 | 18 |
| Post Trial | 15 | 15 | 13 | 7 | 8 | 8 |

Preferred embodiments of the invention have been described by way of example only and modifications may be made thereto without departing from the scope of the invention.

1. An apparatus for releasing a gas into a liquid housed in a container, the apparatus comprising:
a. a gas assembly including a source of compressed gas;
b. a float in fluid communication with the source of compressed gas; and
c. a gas release membrane in fluid communication with the source of compressed gas and the float, the gas release membrane being adapted to release gas into the liquid;
wherein the float has variable buoyancy that causes the float and the gas release membrane to ascend and descend depending on the buoyancy of the float, the buoyancy of the float being reduced as the gas is released into the liquid.

2. The apparatus of claim 1, wherein the source of compressed gas is adapted to be provided outside the container, and the float and at least part of the gas release membrane are adapted to be housed within the container.

3. The apparatus of claim 1, wherein the gas release membrane extends between the gas assembly and the float.

4. The apparatus of claim 1, wherein the gas release membrane partially extends between the source of compressed gas and the float.

5. The apparatus of claim 3, wherein the gas release membrane comprises a flexible tube.

6. The apparatus of claim 1, wherein the float is shaped to create a hydrodynamic effect that causes the float to move generally laterally as it ascends and/or descends.

7. The apparatus of claim 6, wherein the float has one or more laterally extending fins.

8. The apparatus of claim 1, further comprising a valve for controlling the flow of gas from the source of gas to the float and the gas release membrane.

9. The apparatus of claim 1, wherein the gas is or comprises one or more of oxygen, sulphur dioxide, carbon dioxide, and/or nitrogen, either alone or in combination.

10. The apparatus of claim 1, wherein the gas is or comprises oxygen.

11. The apparatus of claim 1, wherein the gas is infused with one or more flavours or aromas.

12. A method of releasing a gas into a liquid comprising:
a. providing a container containing a liquid;
b. providing a source of gas, a float in fluid communication with the source of gas, and a gas release membrane in fluid communication with the source of gas and the float;
c. placing the float and the gas release membrane in the liquid in the container;
d. delivering gas into the gas release membrane and the float thereby increasing the buoyancy of the float, releasing the gas from the source of gas through the gas release membrane into the liquid thereby reducing the buoyancy of the float; and
e. allowing the float to ascend and descend within the liquid in the container depending on the relative buoyancy of the float.

13. The method of claim 12, further comprising controlling the flow of gas from the source of gas to the float and the gas release membrane such that when the pressure within the float reaches an upper threshold, the flow of gas from the source of gas is reduced or prevented and when the pressure within the float drops to a lower threshold, the gas is allowed to flow from the source of gas to the float and the gas release membrane.

14. The method of claim 12, wherein the flow of gas from the source of gas to the float and the gas release membrane is controlled periodically in a cycle in which gas is released for a first period of time and is not released for a second period of time.

15. The method of claim 14, wherein the cycle is between about 20 minutes and about 24 hours.

16. The method of claim 12, wherein the float moves laterally within the liquid in the container as it ascends and descends.

17. The method of claim 12, wherein the gas is or comprises one or more of oxygen, sulphur dioxide, carbon dioxide, and/or nitrogen.

18. The method of claim 12, wherein the gas is or comprises oxygen.

19. The method of claim 12, wherein the liquid is a beverage.

20. The method of claim 19, wherein the beverage is wine.
